(19) United States
(12) Patent Application Publication
(10) Pub. No.: US 2013/0083061 A1
(43) Pub. Date: Apr. 4, 2013

(54) FRONT- AND REAR- SEAT AUGMENTED REALITY VEHICLE GAME SYSTEM TO ENTERTAIN & EDUCATE PASSENGERS

(71) Applicants: PRADYUMNA K. MISHRA, BIRMINGHAM, MI (US); JOHN W. SUH, PALO ALTO, CA (US)

(72) Inventors: PRADYUMNA K. MISHRA, BIRMINGHAM, MI (US); JOHN W. SUH, PALO ALTO, CA (US)

(73) Assignee: GM GLOBAL TECHNOLOGY OPERATIONS LLC, DETROIT, MI (US)

(21) Appl. No.: 13/249,983

(22) Filed: Sep. 30, 2011

(51) Int. Cl. G09G 5/00

(52) U.S. Cl. 345/633

(57) ABSTRACT

In accordance with an exemplary embodiment, an augmented virtual reality game is provided for a vehicle. A method comprises receiving a real-time video image during operation of a vehicle from a camera mounted on the vehicle and merging the real-time video image with one or more virtual images to provide an augmented reality image. The augmented reality image is then transmitted to a display of a gaming device during the operation of the vehicle. A system comprises a camera providing a real-time video image and a controller coupled to the camera. Additionally, a database provides the controller with one or more virtual images so that the controller may provide an augmented reality image by merging the real-time video image with the one or more virtual images. Finally, a transmitter is included for transmitting the augmented reality image to a display of a game device during the operation of the vehicle.

### TECHNICAL FIELD

The technical field generally relates to systems and methodologies for game system that can be enjoyed while riding in a vehicle, and more particularly, to an augmented reality game system where the vehicle plays an active role in the game.

### BACKGROUND

It is now commonplace for vehicles to include onboard electronic control, communication, and safety systems. For example, many vehicles now include navigation systems that utilize wireless global positioning system (GPS) technology that can provide vehicle location information to aid in trip planning and routing. Also, imaging systems are known that provide for real-time fields of view, while radar, sonar and laser based systems are known that can provide for fore, aft and side obstacle detection. Inter-vehicle and roadside-to-vehicle communication systems are being developed with ad-hoc wireless networking providing a basis for distributed sensing, data exchange and advanced warning systems useful for collision mitigation and avoidance. While such systems provide the vehicle operator with valuable information related to the safe operation of the vehicle, this information has not been made available for use by passengers of the vehicle, which generally simply ride along or must entertain themselves until the vehicle arrives at the intended destination.

Virtual reality is a technology commonly used in gaming systems to provide entertainment by allowing people to experience various situations that they will never experience in real life due to spatial and physical restrictions by creating a computer-based artificial environment. In contrast, augmented reality is a system that deals with the combination of real-world images and virtual-world images such as computer graphic images. In other words, augmented reality systems combine a real environment with virtual objects, thereby effectively interacting with users in real time. Passengers could benefit by using real-time, real-world vehicle information in an augmented reality system for both entertainment and educational purposes.

Accordingly, it is desirable to provide an augmented reality game system for use in a vehicle. Also, it is desirable to provide an augmented reality game system using the vehicle in an active role of augmented reality for the educational and entertainment use by passengers of the vehicle. Additionally, other desirable features and characteristics of the present invention will become apparent from the subsequent description taken in conjunction with the accompanying drawings and the foregoing technical field and background.

### BRIEF SUMMARY

In accordance with an exemplary embodiment, an augmented virtual reality game is provided for a vehicle. A method for providing the augmented reality game comprises receiving a real-time video image during operation of a vehicle from a camera mounted on the vehicle and merging the real-time video image with one or more virtual images to provide an augmented reality image. The augmented reality image is then transmitted to a display of a gaming device during the operation of the vehicle.

In accordance with an exemplary embodiment, an augmented virtual reality game is provided for a vehicle. A method for providing the augmented reality game comprises a camera providing a real-time video image and a controller coupled to the camera. Additionally, a database provides the controller with one or more virtual images so that the controller may provide an augmented reality image by merging the real-time video image with the one or more virtual images. Finally, a transmitter is included for transmitting the augmented reality image to a display of a game device during the operation of the vehicle.

### DESCRIPTION OF THE DRAWINGS

The inventive subject matter will hereinafter be described in conjunction with the following drawing figures, wherein like numerals denote like elements, and:

FIG. 1 illustrates the operating environment of a host vehicle employing the augmented reality game system according to exemplary embodiments;

FIG. 2 illustrates an alternative host vehicle according to exemplary embodiments;

FIG. 3 is a functional block diagram of an augmented reality game system according to exemplary embodiments;

FIG. 4 is an illustration of a mobile computing device suitable for use with the augmented reality game system according to exemplary embodiments; and

FIG. 5 is a flow diagram of a method for providing an augmented reality game system according to exemplary embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the drawings depict one exemplary arrangement of elements, additional intervening elements, devices, features, or components may be present in an embodiment of the depicted subject matter.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard,” and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

For the sake of brevity, conventional techniques related to wireless data transmission, radar and other detection systems, GPS systems, vector analysis, traffic modeling, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

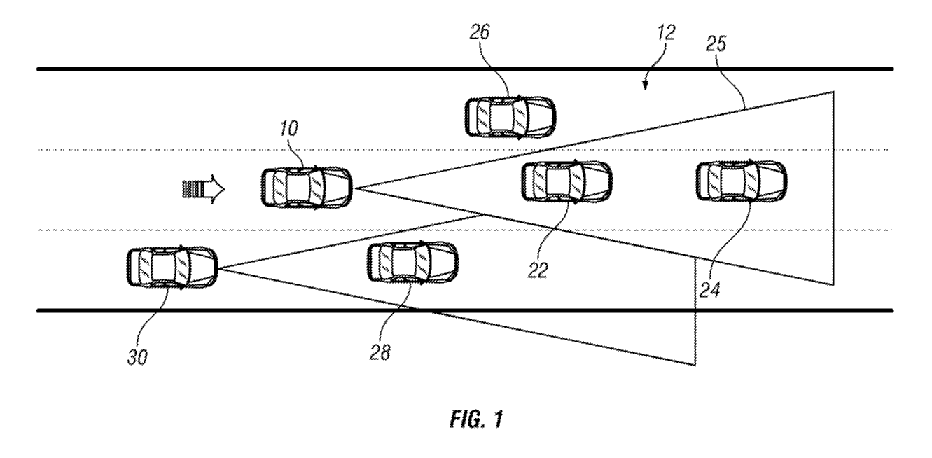

FIG. 1 is a schematic representation of an exemplary operating environment for an embodiment of an augmented reality game system as described herein. In exemplary embodiments, the augmented reality game system involves a host vehicle 10 traveling along a roadway 12. For simplicity and convenience, the system will be described here with reference to a host vehicle 10 and a plurality of neighboring vehicles 22, 24, 26, 28 and 30 that are proximate to host vehicle 10. For gathering real-world images and data for the augmented reality game, the host vehicle 10 includes an onboard vehicle-to-vehicle position awareness system, and neighboring vehicles 22, 24, 26, 28 and 30 may, but need not, have compatible position awareness systems. Additionally, some of the remote vehicles 22, 24, 26, 28 and 30 have communication capabilities with the host vehicle 10 known as vehicle-to-vehicle (V2V) messaging. The host vehicle 10 and those respective neighboring vehicles that have communication capabilities periodically broadcast wireless messages to one another over a respective inter-vehicle communication network, such as, but not limited to, a dedicated short range communication protocol (DSRC) as known in the art. In this way, the host vehicle 10 may obtain additional data for creating virtual images to augment the reality of the real-time images of the augmented reality game of the present disclosure.

Referring still to FIG. 1, the host vehicle 10 is also equipped with vision and object detection sensing devices. Object detection sensing devices include, but are not limited to, radar-based detection devices, vision-based detection devices, and light-based detection devices. Examples of such devices may include radar detectors (e.g., long range and short range radars), cameras and laser devices (e.g., Light Detection and Ranging (LIDAR) or Laser Detection and Ranging (LADAR)). Each respective sensing system detects or captures an image in the respective sensors' field-of-view. The field-of-view is dependent upon the direction in which the object detection sensors are directed. In this example, neighboring vehicles 22 and 24 are detected by a forward-looking camera the object detection sensors of the host vehicle 10 within a field-of-view 25 for a sensed area forward of the host vehicle 10. In the illustrated example, neighboring vehicle 30 also includes vision and object detection sensing devices. Therefore, neighboring vehicle 30 can detect neighboring vehicle 28 using its object detection sensors and transmit (V2V) image and position information of neighboring vehicle 28 which is not in the field of view 25 of the host vehicle 10. As a result, fusing the image and object data detected by neighboring vehicle 30 may allow the host vehicle 10 to construct a more robust augmented reality image surrounding the host vehicle 10. However, in the most fundamental embodiment of the augmented reality game system of the present disclosure, all that is needed is a forward-looking camera image and some virtual reality augmenting elements for conducting any particular game of interest to the passenger. In one embodiment, a game involves an educational driving experience game where a passenger operates a virtual vehicle following the host vehicle in traffic. Game points may be added to or subtracted from a game score depending upon the driving habits exhibited by the gaming passenger. For example, proper vehicle spacing, driving speed and lane change maneuvers add to the game score, while speeding, failing to signal maneuvers or weaving in traffic would cause the game score to be reduced. Alternately, various icons may represent safe, risky or dangerous driving habits to the gaming passenger. Providing an augmented reality driving experience based upon the real-time host vehicle operation provides the gaming passenger with a life-like driving experience for their education and entertainment. Moreover, since the operator (driver) of the host vehicle knows the augmented reality driving game is in progress, the driver is motivated to drive safely in order to set the proper example for the gaming passenger.

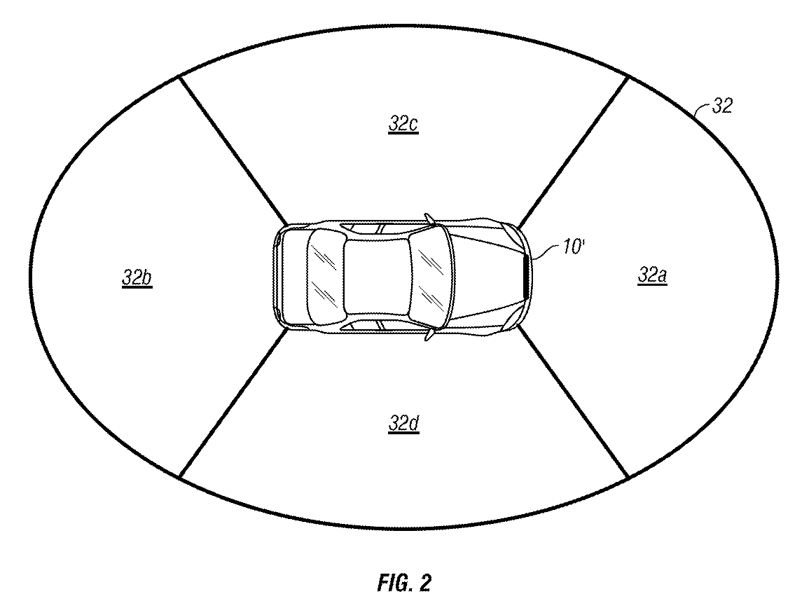

Referring now to FIG. 2, there is shown a top plan view of an alternate embodiment of the host vehicle 10′, showing an exemplary sensor detection zone 32 for host vehicle 10′. For illustrative purposes, detection zone 32 is divided into four subzones corresponding to a fore sensor zone 32a, an aft sensor zone 32b, a driver side sensor zone 32c, and a passenger side sensor zone 32d. This arrangement corresponds to an embodiment having four sensors for the detection and ranging system, although an embodiment of host vehicle 10′ may include more or less than four sensors. It should be appreciated that in operation each of these sensor zones will correspond to a three-dimensional space that need not be shaped or sized as depicted in FIG. 2, and these sensor zones will likely overlap with one another. Moreover, the specific size, shape, and range of each sensor zone (which may be adjustable in the field) can be chosen to suit the needs of the particular deployment and to ensure that host vehicle 10′ will be able to detect all neighboring vehicles of interest.

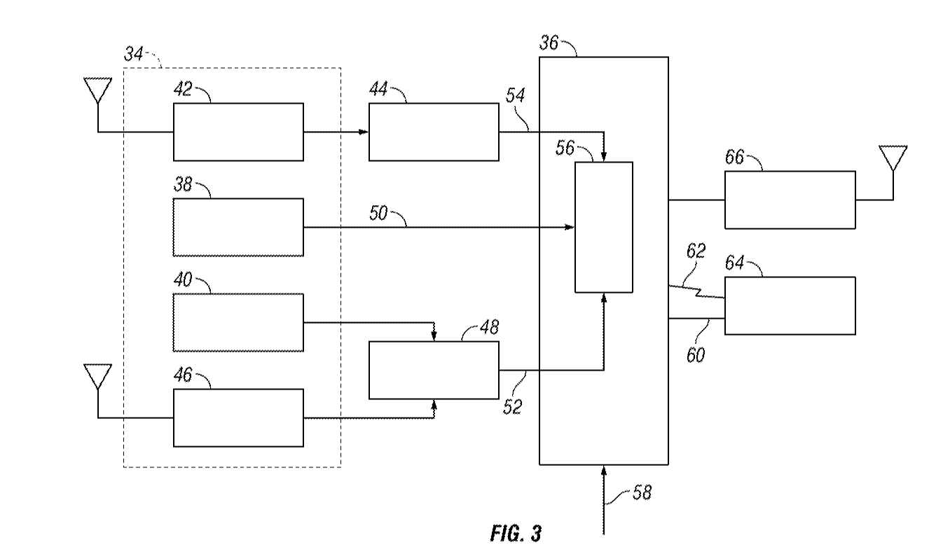

Referring now to FIG. 3, a functional block diagram of the augmented reality game system for use in a host vehicle 10 is shown to include a plurality of sensing systems 34 for providing a variety of data related to the vehicle's surroundings or environment. Signals and data from the sensing systems are provided to a computer based control unit 36. Control unit 36 may include single or multiple controllers operating independently or in a cooperative or networked fashion and comprise such common elements as a microprocessor, read only memory ROM, random access memory RAM, electrically programmable read only memory EPROM, high speed clock, analog to digital (A/D) and digital to analog (D/A) circuitry, and input/output circuitry and devices (I/O) and appropriate signal conditioning and buffer circuitry. Also, control unit 36 may be associated with vehicle dynamics data processing including for example, real time data concerning vehicle velocity, acceleration/deceleration, yaw, steering wheel position, brake and throttle position, and the transmission gear position of the vehicle. Finally, control unit 36 has stored therein, in the form of computer executable program code, algorithms for effecting steps, procedures and processes related to the augmented reality game system of exemplary embodiments of the present disclosure.

Proceeding with the description of the various systems of the host vehicle 10, a first and fundamental sensing system includes an imaging system 38 of one or more video cameras or other similar imaging apparatus including, for example, infrared and night-vision systems, or cooperative combinations thereof for real time object detection. Generally, at least a forward-looking camera is utilized offering the gaming passenger a driver's point-of-view for playing the educational driving game. However, other camera positions can be used to offer the gaming passenger the opportunity to change the view point of the virtual vehicle of the augmented reality driving game.

As used herein, the term imaging system includes, for example, imaging apparatus such as video cameras, infrared and night-vision systems. Exemplary imaging hardware includes a black and white or color CMOS or CCD video camera and analog-to-digital converter circuitry, or the same camera system with digital data interface. Such a camera is mounted in an appropriate location for the desired field of view, which preferably includes a frontal (forward-looking) field of view, and which may further include rear and generally lateral fields of view (see FIG. 2). Multiple cameras are ideal for providing the most diverse augmented reality game in that a full 360 degree field can be sensed and displayed for the gaming passenger. Therefore it be appreciated that multiple position sensors may be situated at various different points along the perimeter of the host vehicle 10 to facilitate imaging from any direction. Alternately, it will be appreciated that partial perimeter coverage (or only a forward-looking view) is completely acceptable and may, in fact, be preferred from a cost/benefit perspective of the vehicle manufacturer. In some embodiments, the imaging system includes object recognition functionality including, for example: road feature recognition such as for lane markers, shoulder features, overpasses or intersections, ramps and the like; common roadside object recognition such as for signage; and, vehicle recognition such as for passenger cars, trucks and other reasonably foreseeable vehicles sharing the roads with the host vehicle 10. Such sensing systems are effective at providing object detection particularly with respect to azimuth position and, with proper training, deterministic object recognition. Also known are single camera image processing systems that can estimate range and range-rate of objects in addition to angular position. Stereo imaging systems are capable of accurately determining the range of objects and can compute range-rate information also. Color camera systems determine the color of the objects/vehicles in the field of view and can be used in rendering virtual objects in corresponding colors when presented on the augmented game system.

Another sensing system suitable for use with an augmented reality game system includes one or more radar, sonar or laser based systems 40 for real-time object detection and range/range-rate/angular position information extraction. As used herein, the term ranging system includes, for example, any adaptable detection and ranging system including, for example, radar, sonar or laser based systems (e.g., Light Detection and Ranging (LIDAR) or Laser Detection and Ranging (LADAR)). Although other conventional types of sensors may be used, sensing system 40 preferably employs either an electromagnetic radar type sensor, a laser radar type sensor, or a pulsed infrared laser type sensor. The sensor or sensor array is preferably situated at or near the perimeter (e.g., front) of the vehicle to thereby facilitate optimal line-of-sight (25 in FIG. 1) position sensing when an object comes within sensing range and field of the subject vehicle perimeter. Again, it is ideal for an optimal game experience to have the most diverse situational awareness possible in a full 360 degree field (See, FIG. 2). Therefore, it is to be understood that multiple position sensors may be situated at various different points and orientations along the perimeter of the vehicle to thereby facilitate sensing of objects, their ranges, range-rates and angular positions from any direction. It is to be understood, however, that partial perimeter coverage is completely acceptable and may, in fact, be preferred from a cost/benefit perspective of the vehicle manufacturer in implementing production systems.

Another sensing system useful for providing data for an augmented reality game system includes a global positioning system (GPS). A GPS system typically includes a global positioning receiver 42 and a GPS database 44 containing detailed road and highway map information in the form of digital map data. The GPS (42 and 44) enables a controller 36 to obtain real-time vehicle position data from GPS satellites in the form of longitude and latitude coordinates. Database 42 provides detailed information related to road and road lanes, identity and position of various objects or landmarks situated along or near roads and topological data. Some of these database objects may include, for example, signs, poles, fire hydrants, barriers, bridges, bridge pillars and overpasses. In addition, database 44 utilized by GPS 42 is easily updateable via remote transmissions (for example, via cellular, direct satellite or other telematics networks) from GPS customer service centers so that detailed information concerning both the identity and position of even temporary signs or blocking structures set up during brief periods of road-related construction is available as well. An example of one such customer service center includes a telematics service system (not shown). Such sensing systems are useful for constructing road images and fixed structures on or near the road and overlaying same relative to the subject vehicle position. GPS 42 is also appreciated for its utility with respect to reduced visibility driving conditions due to weather or ambient lighting, which may have a deleterious affect other sensing systems.

Another sensing system that facilitates a more robust gaming experience includes a vehicle-to-vehicle (V2V) and roadside-to-vehicle (R2V) communications system 46. Communications system 46 communicates with other vehicles (for example, remote vehicles 22, 24, 26, 28 and 30 of FIG. 1 having communication capabilities) within a limited range or field. Such systems may be better known as dedicated short range communications (DSRC) systems. In this way, both the host vehicle and the remote vehicles can transmit and receive respective vehicle data including size, vehicle dynamics data (e.g., speed, acceleration, yaw rate, steering wheel/tire angle, status of brake pedal switch, etc.) and positional data to and from each other via their respective communication systems.

Communications system 46 may also communicate with roadside-to-vehicle communication systems. Such systems provide data such as upcoming traffic conditions, road construction, accidents, road impediments or detours. Additionally, information such as the current and upcoming speed limit, pass or no-pass zones and other information typically provided by roadside signage can be locally transmitted for passing vehicles to receive and process the information.

The data provided by the radar, sonar or laser based systems 40 and the V2V and R2V communication system 46 are processed by a virtual image (icon) database 48 for the provisions of virtual images (e.g., icons, avatars) for incorporation into the live video image provided by the camera 38. Merging or fusing the live image with virtual images provides the augmented reality image for the augmented reality game system of the present disclosure. As used herein, an “augmented reality image” is a merger or fusion of a live video image with virtual images (e.g., icons) forming a simulated model of the environment ahead of or surrounding the host vehicle. Generally, an augmented reality image may include vector calculations for each vehicle of interest within the area of interest, where a vector for a vehicle defines the current heading, position or location, speed, and acceleration/deceleration of the vehicle. An augmented reality image may also include projected, predicted, or extrapolated characteristics for remote vehicles received from the vehicle-to-vehicle communication system 46 to predict or anticipate the heading, position, speed, and possibly other parameters of one or more remote vehicle at some time in the future. In certain embodiments, an augmented reality image may include information about the host vehicle itself and about the environment in which the host vehicle is located, including, without limitation, data related to: the surrounding landscape or hardscape; the road, freeway, or highway upon which the host vehicle is traveling (e.g., navigation or mapping data); lane information; speed limits for the road, freeway, or highway upon which the host vehicle is traveling; and other objects in the zone of interest, such as trees, buildings, signs, light posts, etc.

Accordingly, the live video image 50 the virtual image(s) 52 and the GPS data (e.g., vehicle compass direction, local landmarks) are provided to the controller 36, which includes a fusion module 56 that merges the data and information together to form the augmented reality image. That is, the plurality of data collected from the various sensors 34 are fused into a single collective image that provides a merged real-time (or near real-time) augmented reality image for the augmented reality gaming system of the present disclosure. Optionally, real-time vehicle information 58 (e.g., current speed) may also be merged into the augmented reality image to provide additional information to the gaming passenger.

Once created, the augmented reality image is provided in real-time (or as real-time as possible given some processing time by the controller) to the gaming passenger either via an in-vehicle wired connection 60 (for example a intra-vehicle data bus) or via a wireless connection 62 to a display 64. In a wired embodiment, the display 64 may be built into the back of a seat in front of the passenger or into a flip-out or drop-down overhead video display system (not shown). In a wireless embodiment, the display 64 may be any mobile laptop or tablet computer (e.g., an iPAD® by Apple®) or a portable dedicated gaming system. In an alternate or supplemental embodiment, the augmented reality image may be transmitted to a remote game player by a high-bandwidth, low-latency communication system 66 such as a third generation (3G) or fourth generation (4G) cellular communication system. In this way, a remote (e.g., home) player can follow along on the route driven by the operator of the host vehicle and also play the augmented reality game. Game controls for interactive play may be input by the gaming passenger (or remote player) via a conventional gaming control, touch screen display or other gaming input device.

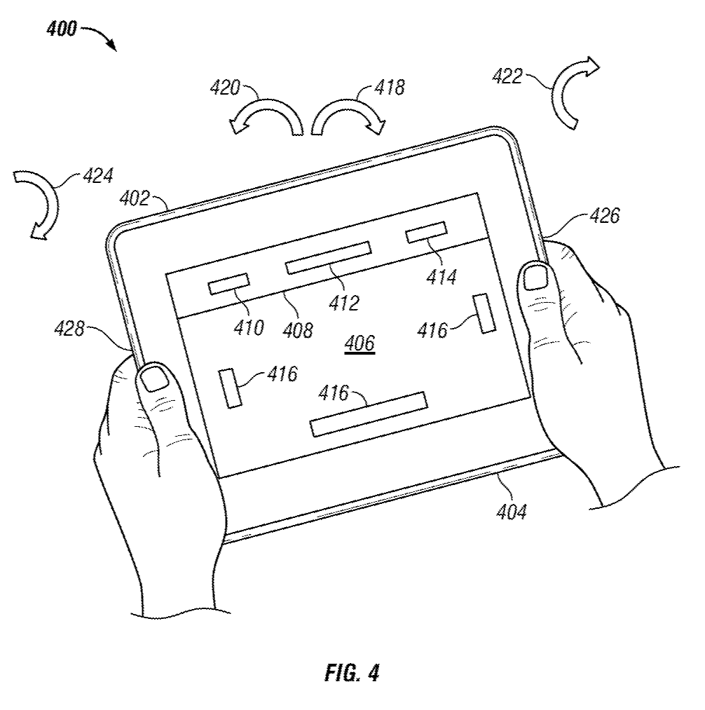

FIG. 4 illustrates an exemplary mobile tablet computer 400 suitable for allowing a passenger to play the augmented reality game of the present disclosure. Typically, a mobile tablet computer 400 includes a housing 402 and a display area 404. During game play, the screen 404 is provided by a live camera area 406 into which various virtual images (icons) 416 may be merged. In some embodiments, a portion 408 of the display 404 is reserved (e.g., a virtual dashboard) for game information such as game score 410, a virtual rearview mirror (assuming a rear-facing camera is available in the host vehicle) or other game information 414 (for example, an indication if the game player is exhibiting safe, reckless or dangerous driving habits). The icons 416 may represent any information derived from the sensors (34 of FIG. 3), including an icon or avatar representing the virtual vehicle being driving by the gaming player. To control the gaming passengers avatar vehicle, the tablet computer 400 may include accelerometers (not shown) that provide steering by turning the tablet computer 400 right (418) or left (420). Acceleration may be controlled by a slight tilt (422) away from the player, while deceleration may be controlled by an opposite tilt (424) toward the player. Turns or changes may be indicated by buttons or touch sensors 426 and 428 to indicate a right or left maneuver, respectively.

In one embodiment, the augmented reality game is realized as an educational driving experience game where a passenger operates a virtual vehicle following the host vehicle in traffic. Game points may be added to or subtracted from a game score (410) depending upon the driving habits exhibited by the gaming passenger. For example, proper vehicle spacing, driving speed and lane change maneuvers add to the game score, while speeding, failing to signal maneuvers or weaving in traffic would cause the game score to be reduced. Alternately, various icons (414) may represent safe, risky or dangerous driving habits to the gaming passenger. Providing an augmented reality driving experience based upon the real-time host vehicle operation provides the gaming passenger with a life-like driving experience for their education and entertainment. Moreover, since the operator (driver) of the host vehicle knows the augmented reality driving game is in progress, the driver is motivated to drive safely in order to set the proper example for the gaming passenger.

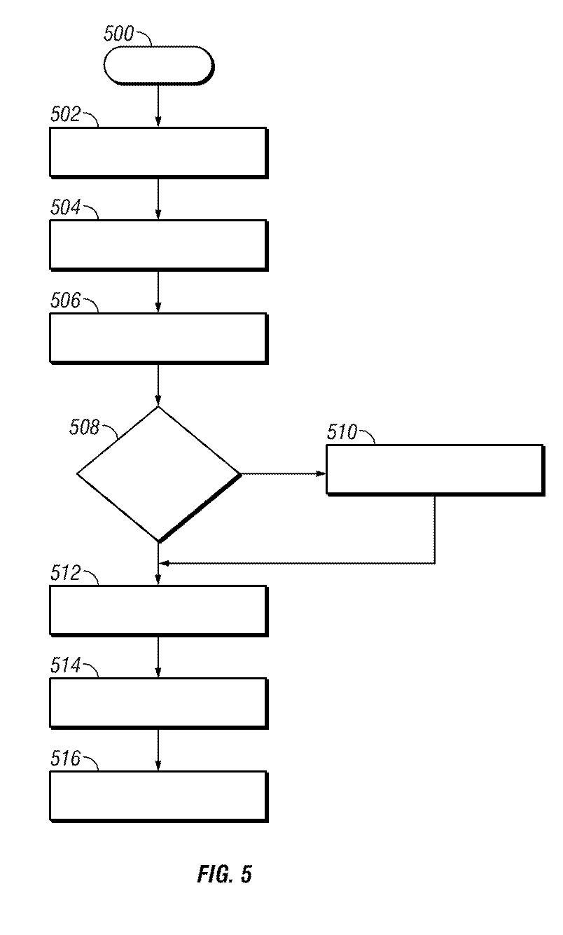

Referring now to FIG. 5, a flow diagram illustrating a method 500 for providing an augmented reality game system is shown. The various tasks performed in connection with the method 500 of FIG. 5 may be performed by software, hardware, firmware, or any combination thereof. For illustrative purposes, the following description of the method of FIG. 5 may refer to elements mentioned above in connection with FIGS. 1-4. In practice, portions of the method of FIG. 5 may be performed by different elements of the described system. It should also be appreciated that the method of FIG. 5 may include any number of additional or alternative tasks and that the method of FIG. 5 may be incorporated into a more comprehensive procedure or process having additional functionality not described in detail herein. Moreover, one or more of the tasks shown in FIG. 5 could be omitted from an embodiment of the method of FIG. 5 as long as the intended overall functionality remains intact.

The method 500 begins in step 502 where the real-time video image (50 in FIG. 3) is captured for merger (fusion) with virtual images provided in step 504. As discussed above, the virtual images may come from a database (48 in FIG. 3) or from GPS data (54 in FIG. 3) or other information sources. Next, in step 506, operational host vehicle data (58 in FIG. 3) may also be collected for fusion with the real-time video image and the virtual image(s). Decision 508 determines whether additional information or data is available such as from V2V or R2V sources (for example, from communication system 46 in FIG. 3). If so, step 510 includes such information or data to be merged with the other information. Else, the routine continues to step 512, which fuses the real-time video image with all other virtual images and data. The now created augmented reality image is transmitted (60, 62 or 66 in FIG. 3) to the game player. Finally, step 516 accepts player input during game play.

Accordingly, an augmented reality game system is provided for a vehicle that provides the gaming passenger with a life-like driving experience for their education and entertainment. Moreover, since the operator (driver) of the host vehicle knows the augmented reality driving game is in progress, the driver is motivated to drive safely in order to set the proper example for the gaming passenger.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing summary and detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method, comprising:
receiving a real-time video image during operation of a vehicle from a camera mounted on the vehicle;
merging the real-time video image vehicle operational data from and one or more virtual images to provide an augmented reality image; and
transmitting the augmented reality image during the operation of the vehicle.

2. The method of claim 1, wherein transmitting further comprises transmitting the augmented reality image to a display mounted within the vehicle.

3. The method of claim 1, wherein transmitting further comprises transmitting the augmented reality image to a display of a mobile computer or game system operating within the vehicle.

4. The method of claim 1, wherein transmitting further comprises transmitting the augmented reality image to a display of a mobile computer or game system operating remote from the vehicle.

5. The method of claim 1, wherein the vehicle operational data comprises at least one of the following group of: vehicle speed, vehicle direction; or vehicle acceleration.

6. The method of claim 1, further comprising:
receiving data from a radar or sonar system during operation of the vehicle; and
merging at least a portion of the data with the real-time video image and the one or more virtual images to provide the augmented reality image.

7. The method of claim 1, further comprising:
receiving global positioning data during operation of the vehicle; and
merging at least a portion of the global positioning data with the real-time video image and the one or more virtual images to provide the augmented reality image.

8. The method of claim 1, further comprising:
receiving information from a road-side information source during operation of the vehicle; and
merging at least a portion of the information with the real-time video image and the one or more virtual images to provide the augmented reality image.

9. The method of claim 1, further comprising:
receiving a second real-time video image from another vehicle; and
merging at least a portion of the second real-time video image with the augmented reality image prior to transmitting.

10. The method of claim 1, further comprising:
receiving information from another vehicle during operation of the vehicle, the information originating from at least one of the following group of information sources: real-time video; radar; laser; sonar; global positioning; or road-side information; and
merging at least a portion of the information with the real-time video image and the one or more virtual images to provide the augmented reality image.

11. A method, comprising:
receiving a real-time video image during operation of a vehicle from a camera mounted on the vehicle;
receiving information from another information source during operation of the vehicle, the information originating from at least one of the following group of information sources: radar; laser; sonar; global positioning; or road-side information;
creating one or more virtual images using the information;
merging the real-time video image with the one or more virtual images to provide an augmented reality game image; and
transmitting the augmented reality game image during the operation of the vehicle.

12. The method of claim 11, wherein transmitting further comprises transmitting the augmented reality game image to a display of a mobile computer or game system operating within the vehicle

13. The method of claim 12, further comprising receiving instructions for the augmented reality game image from the computer or game system operating within the vehicle.

14. The method of claim 13, further comprising merging a game score into the augmented reality game image prior to transmitting the augmented reality game image to the display of the mobile computer or game system operating within the vehicle.

15. The method of claim 11, further comprising:
receiving vehicle operational data during operation of the vehicle; and
merging at least a portion of the vehicle operational data with the real-time video image and the one or more virtual images to provide the augmented reality game image.

16. A vehicle, comprising:
a camera providing a real-time video image;
a controller coupled to the camera and with a database having one or more virtual images and configured to provide an augmented reality image by merging vehicle operational data with the real-time video image and the one or more virtual images; and
a transmitter for transmitting the augmented reality image during the operation of the vehicle.

17. The vehicle of claim 16, wherein the controller is also coupled to at least one of the following group of information sources: radar; laser;
sonar, global positioning; or road-side information.

18. The vehicle of claim 16, wherein the controller processes information provided by the at least one of the group of information sources to provide the one or more virtual images.

19. The vehicle of claim 16, wherein the transmitter transmits the augmented reality image to a display mounted within the vehicle.

20. The vehicle of claim 16, wherein the transmitter transmits the augmented reality image to a display of a mobile computer or game system operating within the vehicle.
